(19) United States
(12) Patent Application Publication
(10) Pub. No.: US 2003/0064800 A1
(43) Pub. Date: Apr. 3, 2003

(54) Video gaming machine with pop-up windows

(76) Inventors: James P. Jackson, Henderson, NV (US); Tricia A. Tylman, Las Vegas, NV (US); Steven D. Rood, Las Vegas, NV (US)

Correspondence Address: SKJERVEN MORRILL LLP, 25 METRO DRIVE, SUITE 700, SAN JOSE, CA, 95110, US

(21) Appl. No.: 09/968,470

(22) Filed: Sep. 28, 2001

(51) Int. Cl. A63F 13/00

(52) U.S. Cl. 463/30; 463/1; 463/16

(57) ABSTRACT

A video gaming machine is described that uses a touch screen to display the game. Touching various icons on the screen, such as the symbols on simulated reels, pay line identifiers, and other icons, cause there to be generated an associated pop-up window or other overlay highlighting or explaining the selected feature. Numerous examples are given.

### FIELD OF THE INVENTION

This invention relates to gaming machines and, in particular, to video gaming machines.

### BACKGROUND

Games displayed by video gaming machines are becoming increasingly complex. For example, there may be pay lines that are not straight lines; there may be additional features and special symbols that are not readily apparent to a player; there may be complex pay tables; and the rules for playing the game may be confusing.

Certain types of video games include a “help” menu that the player may access to understand certain aspects of the game. However, such help menus are generally confusing to many players; the text in the help menu may be difficult to understand; and the player may speak a language different from the text. For these and various other reasons, it is desirable to provide a video gaming machine that is more easily understood to a player yet provides all the features and excitement as any modem gaming machine.

### SUMMARY

A video gaming machine is described that uses a touch screen to display the game. Touching various icons on the screen, such as the symbols on simulated reels, pay line identifiers, and other icons, cause there to be generated an associated pop-up window (or other overlay) highlighting or explaining the selected feature. The invention may be applied to video reel type machines, poker machines, blackjack machines, keno, and other types of video gaming machines.

Using such overlays reduces clutter on the display screen, can be graphically intensive to avoid the use of text, can be easily understood, can be quickly and logically accessed, and may even include animation.

### BRIEF DESCRIPTION OF THE DRAWINGS

FIG. 1 is a front view of a video gaming machine incorporating the present invention.

FIG. 2 is a block diagram of the basic components of a conventional gaming machine platform that can be used to implement the invention by programming memory in the machine with the video gaming routines and routines initiated by a player touching the touch screen.

FIGS. 3-11 illustrate the touch screen display in response to the player touching various icons on the touch screen so as to provide additional information pertaining to the icon.

### DETAILED DESCRIPTION

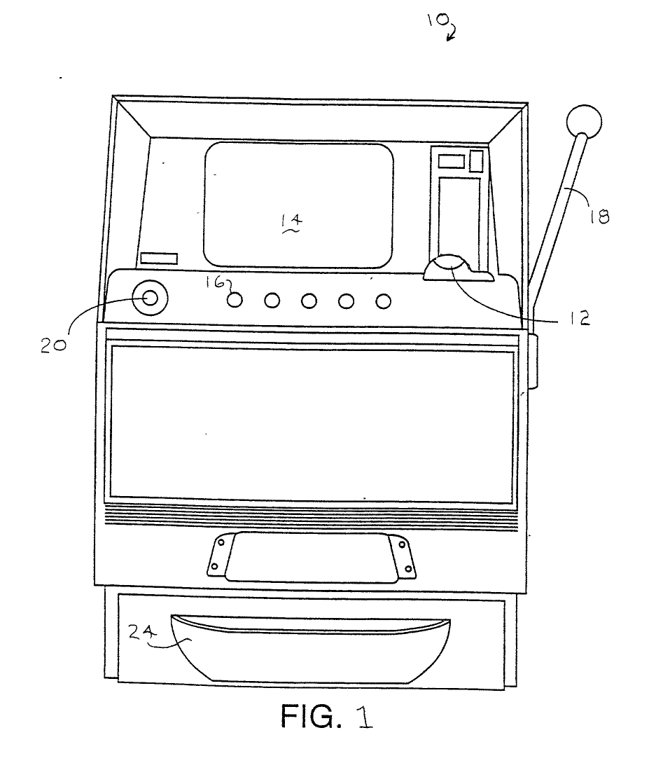

FIG. 1 is front view of a video gaming machine 10 in which the player inserts currency (or a monetary equivalent) into the machine to obtain credits. Such video game platforms are conventional, and the main differences between video gaming machines are basically the look of the front of the machines, the control buttons for allowing the player to make selections, and the programming of the various memory modules within the video gaming machine to carry out the video game routine.

Machine 10 includes a coin slot 12 and/or a slot for receiving paper currency or other monetary equivalent. All the various forms of making a wager are envisioned.

The number of credits available to the player is then displayed on a touch screen 14. Touch screens used in gaming machines are conventional. The player may input her selection via virtual buttons on screen 14, which the player touches to make a selection. Player input may, instead, be made by mechanical buttons 16, where the function of each button 16 is dependent upon the particular game to be played (e.g., video poker, video reels, etc.). One of the virtual or mechanical buttons 16 may be a bet button to allow the player to bet a certain number of available credits.

The player then pulls a handle 18 or presses a start button 20 to begin the primary game. The most common types of primary games are games that rotate simulated reels or video card games. The outcome of the game is typically determined by a pseudo-random number routine. One type of video gaming machine that rotates simulated reels is described in U.S. Pat. No. 6,159,097, incorporated herein by reference.

Depending upon the outcome of the game, the machine may issue credits, decrement credits, or initiate a bonus game. The initiation of the bonus game may also be accompanied by the player winning a certain number of credits. Ultimately, the player may cash out the credits by pressing a cash-out button. Upon cash-out, the equivalent number of coins may be deposited in an output tray 24 or, in other embodiments, a printed ticket may be issued, a magnetic stripe on a card may be magnetically written to, or the credits may be downloaded to a server for cashing out by the player at a later time.

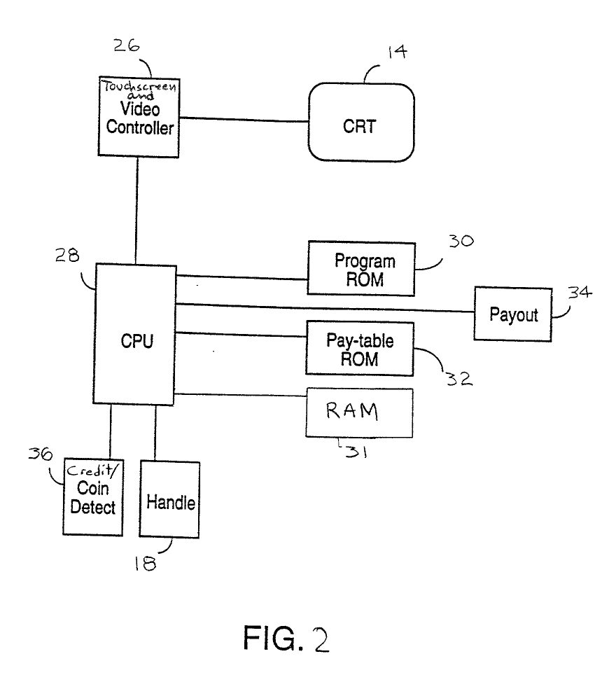

FIG. 2 illustrates the basic components of the video gaming machine of FIG. 1, where touch screen 14 forms part of a CRT whose display is controlled by a video controller 26. Video controller 26 receives relatively simple signals output by a CPU 28 and controls the CRT to display the complex pixel images on the touch screen 14. A program ROM 30 contains the game program and other programs for displaying images on the touch screen 14. The game program may be incorporated on a number of memory chips or a CD, and a separate memory may be provided for the display programs. A RAM 31 is used by CPU 28 for storing data during operation.

A pay-table ROM 32 receives a signal by CPU 28 identifying the outcome of the game and associates this signal with the number of award credits to be granted to the player. Upon the player cashing out, a payout mechanism 34 either controls a coin hopper to output coins, prints a ticket, or writes to a magnetic stripe on a card, depending on the particular gaming machine platform used.

A conventional credit/coin detector 36 detects that money has been deposited in order to play the game, and a conventional handle 18 (or play button) initiates the game.

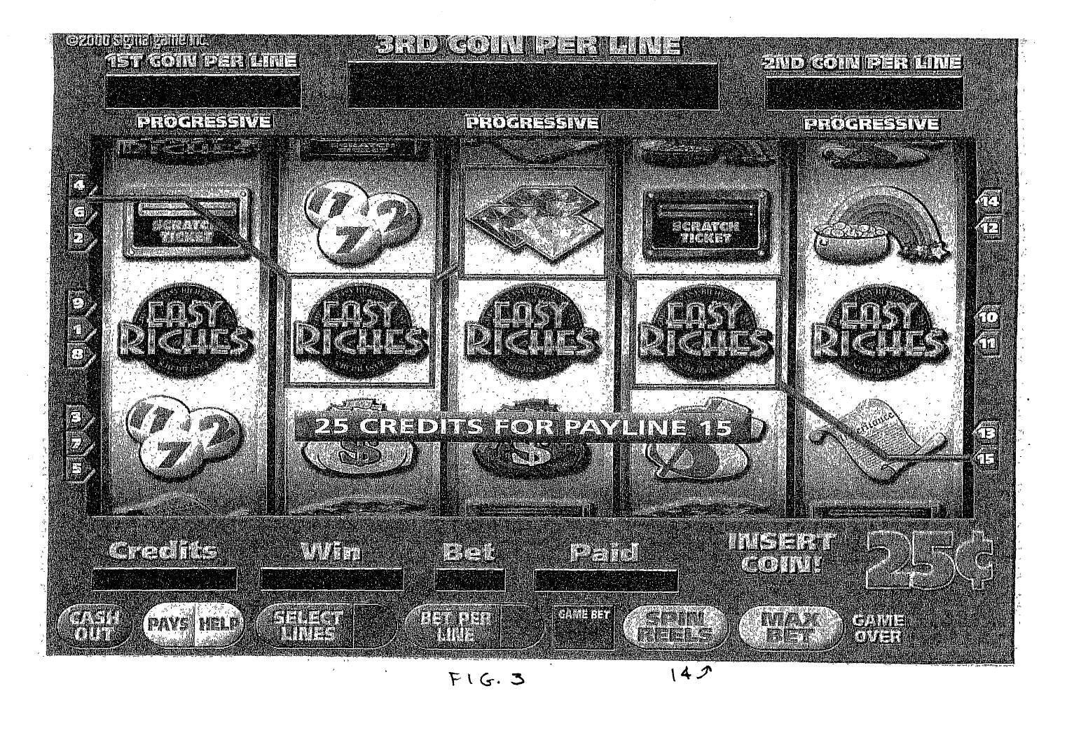

FIGS. 3-11 depict the screen displays after a player has touched particular icons on the screen in order to obtain additional information associated with such icons. The background display of the reels in FIG. 3 is arbitrary and will typically be the result of the last game played.

The touch screen 14, in one embodiment, contains essentially transparent circuitry that detects the X-Y position of a player's finger contacting the touch screen. Such detection may be by a change in capacitance at that particular X-Y position. This detected position is then cross-referenced to a particular program routine that creates an associated pop-up window overlaid on the previous screen display. The operation of touch screens and the processing used to generate displays in response to a person touching the touch screen are extremely well known and need not be described herein.

In FIG. 3, a player desiring to know more about the various pay lines (in this case pay lines 1-15) and pay outs may touch one of the pay line numbers on the left and right of the screen for more information about that particular pay line. In the example of FIG. 3, the player touched the “15” icon, which then caused the pay line 15 to be highlighted as well as caused to be displayed the number of credits (25 credits) awarded the player for the particular combination of symbols across pay line 15. The insertion of additional coins activates more pay lines. The pay line overlay also displays squares around only those symbols that contributed to the win. This makes it easy for the player to see why she has won.

Once another icon is touched or the game is played, the previous video overlay is removed. Additionally, the overlay may disappear after a preset time. For overlays that are more time consuming to understand, an exit button on the overlay is provided.

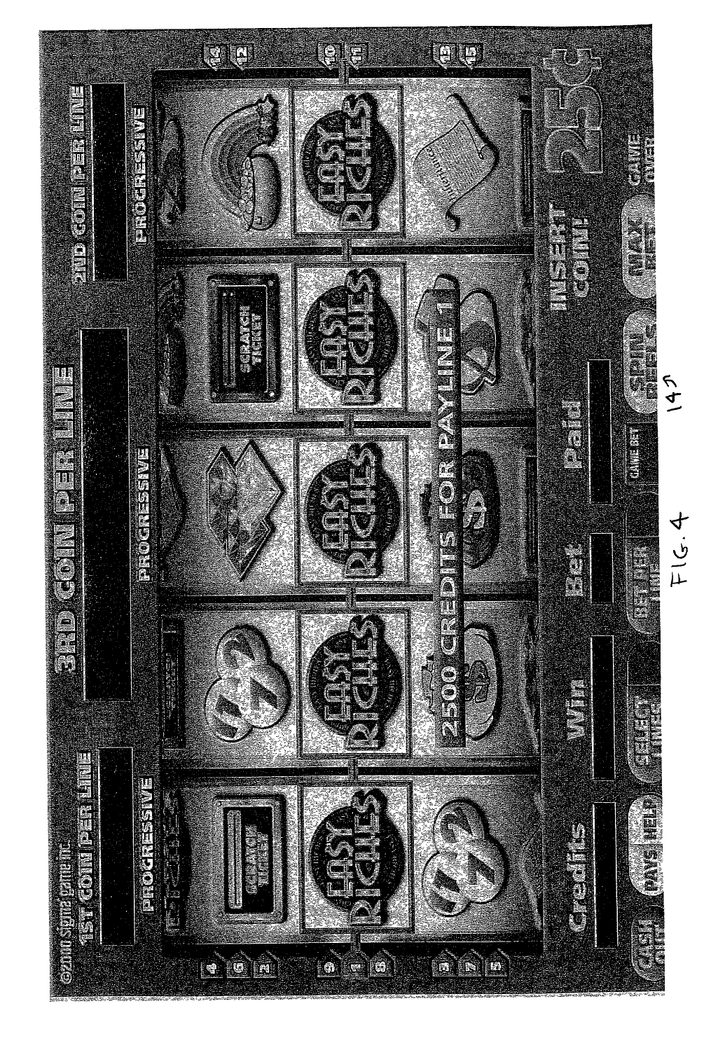

FIG. 4 illustrates the display after the player has touched the pay line icon “1” on the left side of the screen, which shows that pay line 1 is the center line across five symbols. For the particular game result shown in FIG. 4, five winning symbols are across pay line 1. As also seen, a window beneath the pay line overlay identifies that an award of 2500 credits was paid for the winning combination across pay line 1. This is contrasted with only 25 credits awarded for the winning combination across pay line 15.

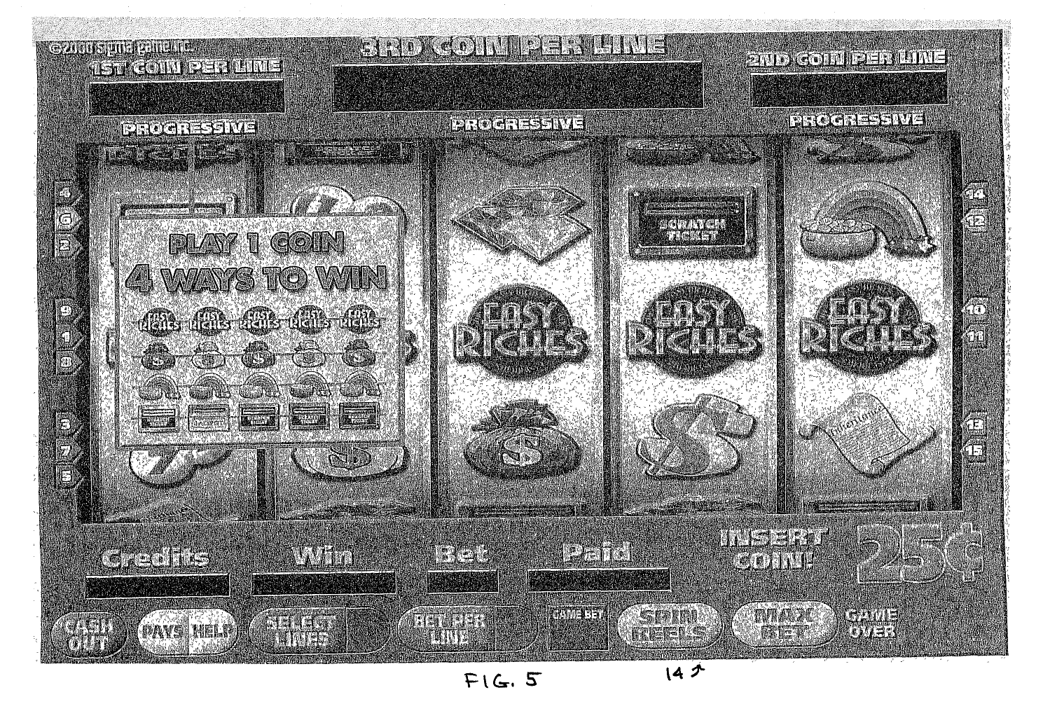

FIG. 5 illustrates the display after the player has touched the icon “progressive” beneath the displayed phrase “1ST COIN PER LINE.” The pop-up window that is displayed in response to the player touching the word “progressive” identifies the various winning symbol combinations for a play of one coin. Similar pop-up windows appear upon the player touching the word “progressive” under either the “2ND COIN PER LINE” phrase or the “3RD COIN PER LINE” phrase, but identifying that the play is for two or three coins, respectively. Additional winning combinations may be included when additional credits are bet.

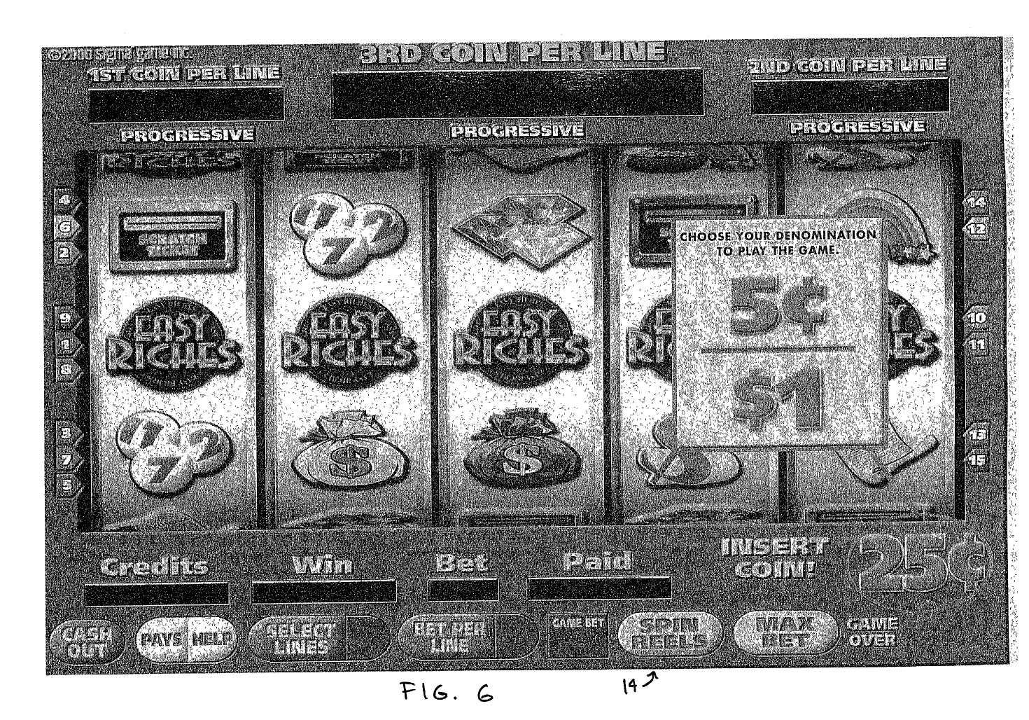

FIG. 6 illustrates the display after the player has touched the area identifying the denomination icon, in this case the “25¢” icon. When the player touched the “25¢” icon, a window popped up identifying the other available denominations of 5¢ and $1. The player may then touch either of the two alternative denominations to cause the chosen denomination to replace the “25¢” icon. As will be seen, this will affect other displays that identify the actual monetary value awarded rather than credits.

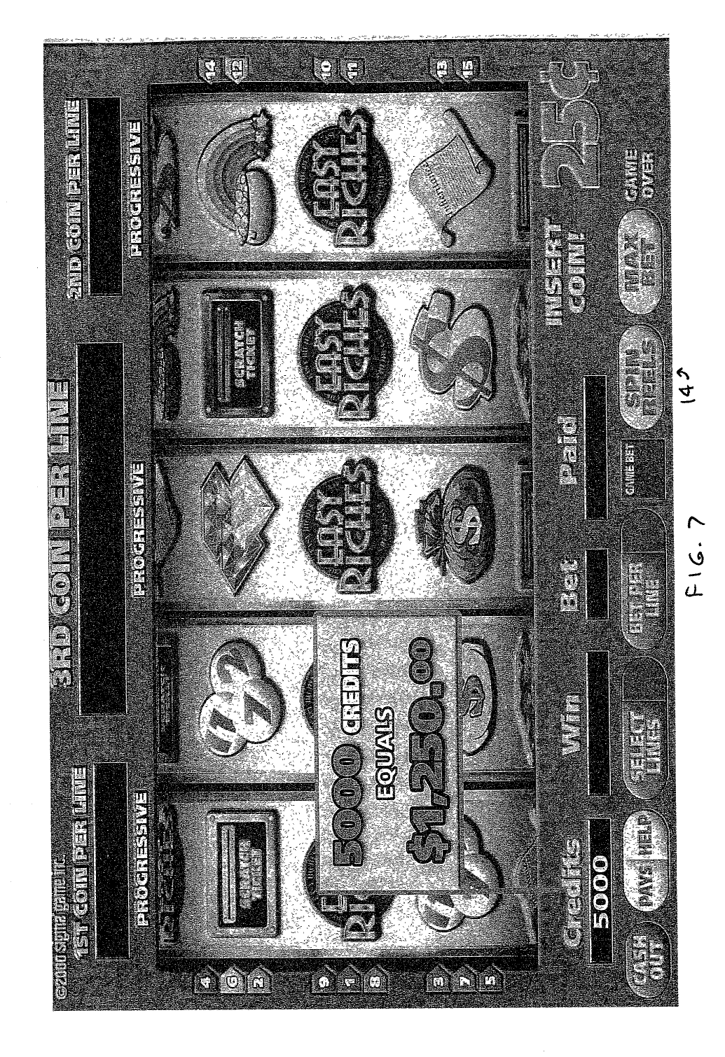

FIG. 7 illustrates the display after the player has touched the “credits” icon. The number of credits that the player has accumulated in the machine multiplied by the denomination value (in this case 25¢) is determined by the CPU 28, and the actual monetary value of the credits is identified in the pop-up window.

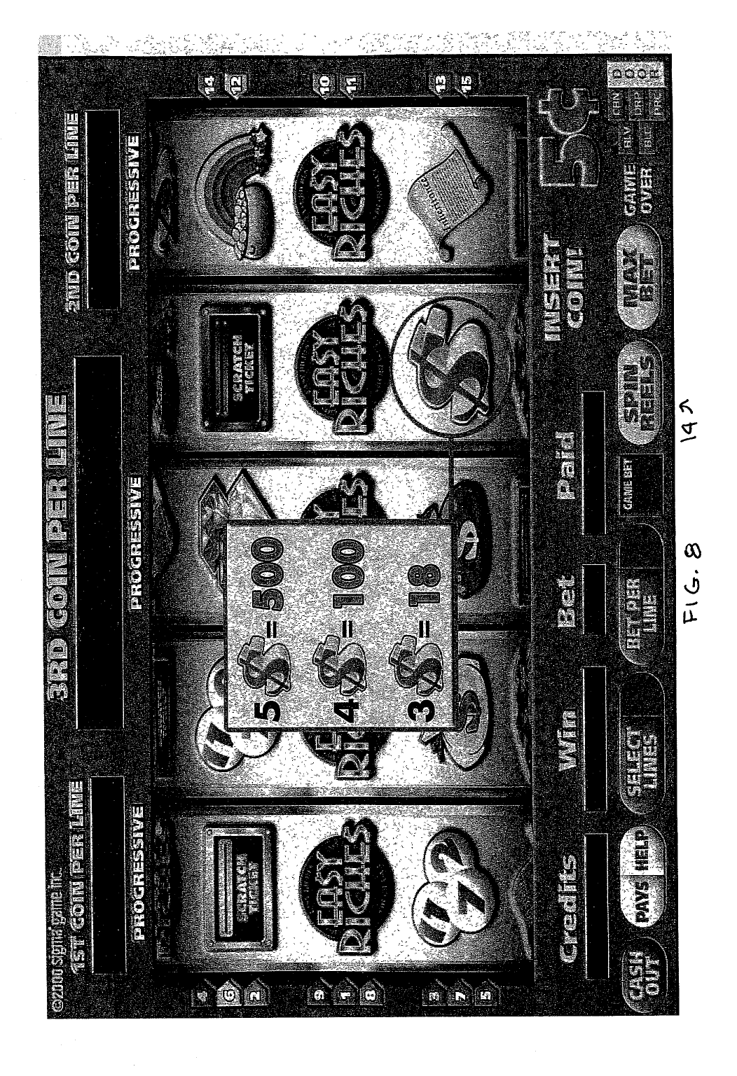

FIG. 8 illustrates the display after the player has touched the “$” symbol on the reels to identify the award to be granted for that particular symbol across a pay line. As seen, the pop-up window identifies different credit awards depending upon the number of times that the symbol “$” appears across an activated pay line. Thus, a complex pay table can be made easily understandable using the pop-up windows.

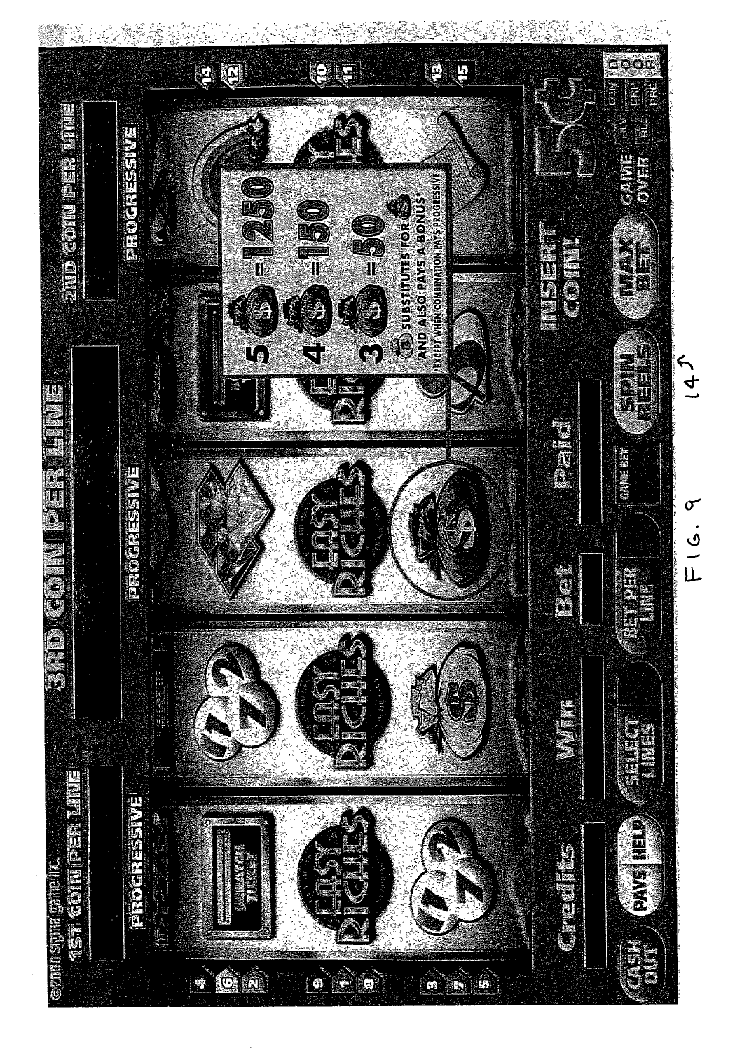

FIG. 9 illustrates the display after the player has touched the icon of the bag of “$” on the reel. Note that the pop-up window shows that 3, 4, or 5 of those symbols across an activated pay line award more credits than the combination of the “$” symbols shown in FIG. 8.

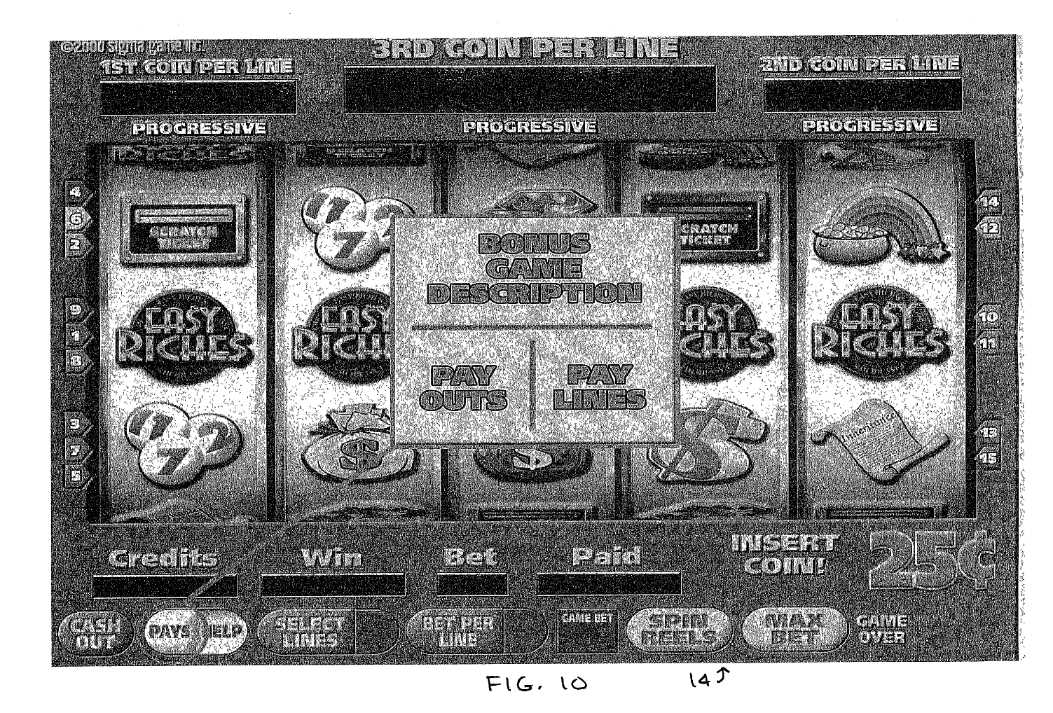

FIG. 10 illustrates the display after the player has touched the “pays” icon at the bottom of the screen. The pop-up window offers the player selections in order to obtain additional information. For example, if the player then chose the option of “pay lines” from the pop-up window, all 15 pay lines, each in a different color, would then be overlaid on the screen, or additional text regarding pay lines is displayed in a second overlay. If the player chose the option “pay outs,” a second overlay would appear providing additional information on pay outs.

In the particular embodiment shown in FIG. 10, upon a certain combination of symbols on a pay line, a special bonus game is initiated, and such a bonus game is described in another pop-up window if the player touches the portion of the pop-up window labeled “bonus game description.” Such a bonus game may be any type of game either related to a reel type game or a completely different game.

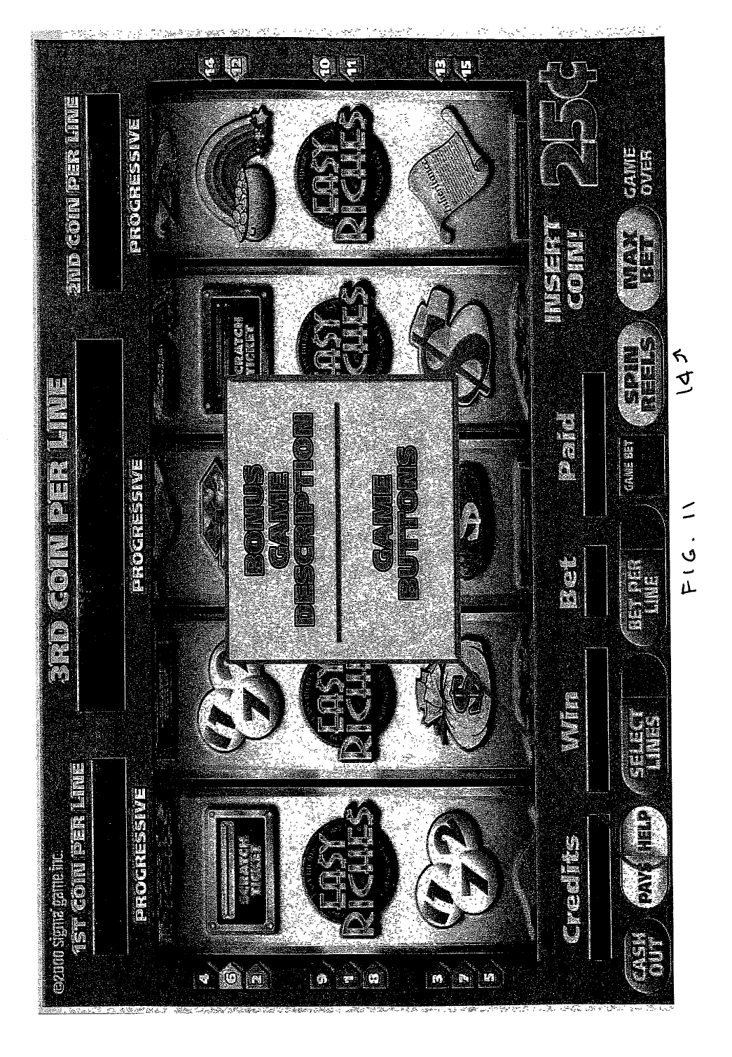

FIG. 11 illustrates the display after the player has touched the “HELP” icon. The pop-up window gives the player additional options to choose from relating to the game buttons or the bonus game description.

Numerous other embodiments of overlays are envisioned. For example, animation may also be displayed in response to touching an icon to illustrate actions to be taken or to create a more amusing overlay. The overlays will depend on the particular game to be played. Generating the overlays in response to a player touching portions of the simulated reels or other icons on the screen pertaining to the game itself greatly reduces the complexity of the display glass and the screen. Such simplification of the display avoids intimidating players unfamiliar with the game. By using graphics to a large extent, the player does not have to read instructions, resulting in faster understanding of the rules of the game. Additionally, by avoiding complex instructions on the display glass, a single video gaming platform may be used for a variety of different games since the differences will reside in the programs loaded into the game's memory rather than the printing on the display glass.

The invention may be applied to video reel type machines, poker machines, blackjack machines, keno, and other types of video gaming machines. In the example of a video poker game, there may be an icon on the touch screen to display examples of winning hands such as a straight, flush, etc.

While particular embodiments of the present invention have been shown and described, it will be obvious to those skilled in the art that changes and modifications may be made without departing from this invention in its broader aspects and, therefore, the appended claims are to encompass within their scope all such changes and modifications as fall within the true spirit and scope of this invention.

What is claimed is:

1. A video gaming machine comprising:
a touch display screen; and
at least one processor for displaying a game on said screen, said at least one processor causing to be generated a graphical information overlay on said screen, in response to a player touching a part of said screen displaying an aspect of said game for which additional information is desired, wherein said overlay provides additional information relating to said aspect of said game.

2. The machine of claim 1 wherein said overlay displays animation.

3. The machine of claim 1 wherein said overlay comprises a pop-up window.

4. The machine of claim 1 wherein said overlay displays a payment amount upon said player touching a pay-related icon on said screen.

5. The machine of claim 1 wherein said overlay displays a monetary amount corresponding to a number of credits available to said player.

6. The machine of claim 1 wherein said overlay includes text.

7. The machine of claim 1 wherein said overlay includes graphics.

8. The machine of claim 1 wherein said part of said screen displaying an aspect of said game for which additional information is desired comprises a part of said screen displaying a pay out icon.

9. The machine of claim 1 wherein said overlay displays a plurality of available denominations that may be paid into said machine when said player touches a portion of the said screen representing a denomination icon.

10. The machine of claim 1 wherein said overlay displays options to be selected by a player by touching said options, a selection of an option generating an additional overlay.

11. The machine of claim 1 wherein said at least one processor for displaying a game on said screen and said at least one processor causing to be generated a graphical information overlay on said screen are the same processor.

12. The machine of claim 1 wherein said game comprises randomly displaying a plurality of symbols across at least one pay line, a predetermined arrangement of certain ones of said symbols across an activated pay line resulting in a win for a player

13. The machine of claim 12 wherein said overlay displays a payment amount in response to said player touching an icon corresponding to a pay line.

14. The machine of claim 12 wherein said overlay displays an associated pay out for a combination of certain symbols for a number of credits played.

15. The machine of claim 12 wherein said part of said screen displaying an aspect of said game for which additional information is desired comprises a part of said screen displaying a symbol on a simulated reel.

16. The machine of claim 12 wherein said part of said screen displaying an aspect of said game for which additional information is desired comprises a part of said screen displaying a pay line icon.

17. The machine of claim 12 wherein said overlay highlights a particular pay line selected by said player by touching an icon for said pay line.

18. The machine of claim 17 wherein said overlay also identifies symbols on said particular pay line that contributed to a win.

19. The machine of claim 12 wherein said randomly displaying said symbols comprises pseudo-randomly displaying said symbols.

20. The machine of claim 12 wherein said overlay displays possible awards associated with combinations of certain ones of said symbols upon said player touching one of said certain ones of said symbols.

21. A method performed by a video gaming machine having a touch screen for displaying a game, said method comprising:
displaying a game on said screen; and
causing to be generated a graphical information overlay on said screen, in response to a player touching a part of said screen displaying an aspect of said game for which additional information is desired, wherein said overlay provides additional information relating to said aspect of said game.

22. The method of claim 21 wherein said overlay displays animation.

23. The method of claim 21 wherein said overlay comprises a pop-up window.

24. The method of claim 21 wherein said overlay displays a payment amount upon said player touching a pay-related icon on said screen.

25. The method of claim 21 wherein said overlay displays a monetary amount corresponding to a number of credits available to said player.

26. The method of claim 21 wherein said overlay includes text.

27. The method of claim 21 wherein said overlay includes graphics.

28. The method of claim 21 wherein said part of said screen displaying an aspect of said game for which additional information is desired comprises a part of said screen displaying a pay out icon.

29. The method of claim 21 wherein said overlay displays a plurality of available denominations that may be paid into said machine when said player touches a portion of the said screen representing a denomination icon.

30. The method of claim 21 wherein said overlay displays options to be selected by a player by touching said options, a selection of an option generating an additional overlay.

31. The method of claim 21 wherein said displaying said game comprises:
randomly displaying a plurality of symbols across at least one pay line, a predetermined arrangement of certain ones of said symbols across an activated pay line resulting in a win for a player.

32. The method of claim 31 wherein said overlay displays a payment amount in response to said player touching an icon corresponding to a pay line.

33. The method of claim 31 wherein said overlay displays an associated pay out for a combination of certain symbols for a number of credits played.

34. The method of claim 31 wherein said part of said screen displaying an aspect of said game for which additional information is desired comprises a part of said screen displaying a symbol on a simulated reel.

35. The method of claim 31 wherein said part of said screen displaying an aspect of said game for which additional information is desired comprises a part of said screen displaying a pay line icon.

36. The method of claim 31 wherein said overlay highlights a particular pay line selected by said player by touching an icon for said pay line.

37. The method of claim 36 wherein said overlay also identifies symbols on said particular pay line that contributed to a win.

38. The method of claim 31 wherein said randomly displaying said symbols comprises pseudo-randomly displaying said symbols.

39. The method of claim 31 wherein said overlay displays possible awards associated with combinations of certain ones of said symbols upon said player touching one of said certain ones of said symbols.
